(19) United States
(12) Patent Application Publication
(10) Pub. No.: US 2026/0175195 A1
(43) Pub. Date: Jun. 25, 2026

(54) CATALYST MATERIAL AND ITS APPLICATION

(71) Applicant: CHYI DING TECHNOLOGIES CO., LTD., Hsinchu County (TW)

(72) Inventors: Yu-Cheng LIU, New Taipei City (TW); Ting-Fang CHANG, Chiayi County (TW)

(21) Appl. No.: 19/001,180

(22) Filed: Dec. 24, 2024

(51) Int. Cl. B01J 20/28; B01D 39/16; B01D 69/10; B01J 23/00

(52) U.S. Cl. CPC B01J 20/28061; B01D 39/16; B01D 69/1071; B01J 20/28071; B01J 20/28073; B01J 20/28083; B01J 23/00

(57) ABSTRACT

A catalyst material includes a carrier and a first transition metal and a second transition metal, each loaded on the carrier in a single-atom form. The carrier is selected from the group consisting of iron-nickel oxide, silicon-aluminum oxide, aluminum oxide, and titanium dioxide. The first transition metal is Fe, Cu, Ir, or Pt. The second transition metal may be Pd, Ni, or Co. Based on a total catalyst material weight of 100 wt %, the combined weight percentage of the first and second transition metals is in a range from 0.2 wt % to 2.5 wt %. Based on a total molar fraction of 100% for the first and second transition metals, the molar ratio of the second transition metal to the first transition metal ranges from 1 to 2. This catalyst material is designed to treat airborne molecular contaminants at concentrations ranging from ppb to ppm levels.

### BACKGROUND OF THE INVENTION

### a) Field of the Invention

The present invention relates to catalyst materials, specifically those designed for the decomposition of airborne molecular contaminants (AMC) and their applications.

### b) Description of the Prior Arts

With the rapid development of the semiconductor industry, large amounts of chemical substances, such as acidic and alkaline solutions and organic solvents, are extensively used in production processes. During the etching or cleaning processes, these chemicals often volatilize or are discharged and are collected in exhaust systems. These volatile chemicals are collectively referred to as airborne molecular contamination (AMC). The increasing generation of AMC emissions poses not only a threat to the health of personnel in the operating environment but also has a negative impact on product yield, and it may even cause environmental pollution through exhaust discharge. Therefore, how to effectively treat and remove these trace (ranging from ppb to ppm levels) pollutants has become a significant concern in the industry.

In the prior art, various AMC removal technologies have been developed and applied, including physical methods (such as gas-phase adsorption and chemical filtration) and chemical methods (such as solvent soaking and chemical cleaning). Physical methods are generally efficient and environmentally friendly, however, they may have limitations in removing trace (ppb-level) airborne molecular contaminants. Chemical methods have stronger removal capabilities, but the cumbersome post-treatment steps may have adverse environmental effects. Additionally, for specific volatile organic compounds (VOCs), the effectiveness of these traditional methods may be suboptimal, and treatment methods relying on simple filter adsorption or high-temperature incineration are energy-intensive, making them unsustainable. Thus, finding ways to address such pollutants through efficient catalysts under mild conditions is a pressing challenge.

Current catalytic technologies mostly focus on micron-scale (μm) or nanoscale (nm) catalytic materials. Although catalysts of these sizes can provide effective catalytic activity in some applications, their efficiency is limited when dealing with even trace pollutants (e.g., ppb-level VOCs). Designing catalysts at the single-atom level has emerged as a key strategy for enhancing catalytic performance. Single-atom catalysts feature highly dispersed and active metal centers, theoretically offering more active sites and significantly enhancing catalytic efficiency.

It is noteworthy that Patent Document TW1733200B discloses a method for preparing a single-atom catalyst, which involves the preparation of mesoporous transition metal oxides using a mesoporous template, followed by anchoring single-atom noble metals to form the catalyst. However, the use of mesoporous templates makes the process complex, adding to production costs and time. Moreover, the preparation of mesoporous supports requires precise template control and removal steps, which present efficiency issues in large-scale industrial production. Therefore, although this technology has advantages in the preparation of single-atom catalysts, its application in practical production is limited.

### SUMMARY OF THE INVENTION

To overcome the above-mentioned technical problems, the objective of the present invention is to provide a catalyst material and its application. The invention uses a simplified process to directly synthesize high-performance single-atom catalyst material without employing mesoporous templates, achieving precise dispersion of single-atom level metals while maintaining high catalytic activity, capable of treating volatile pollutants at concentrations ranging from ppb to ppm, thereby significantly enhancing treatment efficiency. Furthermore, the catalyst material of the present invention can be further added to a support material through impregnation, coating, mixing, or spraying techniques to produce a filter material, enabling the successful application of the catalyst material in filtration technology and expanding its application potential in the field. As a result, the simplified process of the present invention not only effectively reduces production costs but also allows for flexible application in large-scale industrial production, providing broad application prospects, particularly suitable for gas pollutant treatment needs in modern chemical industries, thus becoming a potential solution.

To achieve the above objectives, the present invention provides a catalyst material, wherein the catalyst material comprises:
a carrier; and
a first transition metal and a second transition metal, the first transition metal and the second transition metal being loaded in a single-atom form on the carrier;
wherein the carrier is selected from the group consisting of iron-nickel oxide (FeₓNi_{y}O_{z}), silicon-aluminum oxide (AlₓSi_{y}O_{z}), aluminium oxide (Al₂O₃), and titanium dioxide (TiO₂); the first transition metal is Fe, Cu, Ir, or Pt, and the second transition metal is Pd, Ni, or Co; based on a total catalyst material weight of 100 wt %, the combined weight percentage of the first transition metal and the second transition metal ranges from 0.2 wt % to 2.5 wt %; and, based on a total molar fraction of 100% for the first transition metal and the second transition metal, the molar fraction of the second transition metal is 1 to 2 times the molar fraction of the first transition metal.

According to the present invention, when the carrier is iron-nickel oxide (FeₓNi_{y}O_{z}), if x=1, then y=1 or 2, z=3 or 4; if x=2, then y=1, z=4; if x=5, then y=1, z=8. In one embodiment, the FeₓNi_{y}O_{z} may specifically be FeNiO₃, FeNi₂O₄, Fe₂NiO₄, or Fe₅NiO₈.

According to the present invention, when the carrier is silicon-aluminum oxide (AlₓSi_{y}O_{z}), if x=1, then y=1, 2, 3, or 4, and z=3, 6, 8, or 10; if x=2, then y=1 or 2, and z=5, 6, 7, or 9. In one embodiment, the AlₓSi_{y}O_{z} may specifically be AlSiO₃, AlSi₂O₆, AlSi₃O₈, AlSi₄O₁₀, Al₂SiO₅, Al₂SiO₆, Al₂Si₂O₆, Al₂Si₂O₇, or Al₂Si₂O₉.

According to the present invention, when the carrier is silicon-aluminum oxide (AlₓSi_{y}O_{z}), the first transition metal may be selected from Fe or Cu, and the second transition metal may be selected from Pd, Ni, or Co.

According to the present invention, when the carrier is titanium dioxide (TiO₂), the first transition metal may be Ir, and the second transition metal may be Pd.

According to the present invention, when the carrier is iron-nickel oxide (FeₓNi_{y}O_{z}), the first transition metal may be Pt, while the second transition metal may be Pd.

According to the present invention, when the carrier is aluminium oxide (Al₂O₃), the first transition metal may be Pt, and the second transition metal may be Pd, with Pt being deposited or coated on the surface of Pd.

In one embodiment, when the first transition metal is Fe, the Fe precursor may be selected from Fe(NO₃)₃·9H₂O (iron nitrate), FeCl₃ (ferric chloride), FeSO₄·7H₂O (ferrous sulfate heptahydrate), FeCk₂·4H₂O (ferrous chloride tetrahydrate), Fe(CH₃COO)₂ (ferrous acetate), Fe(CO)₅ (iron pentacarbonyl), or Fe₂(SO₄)₃ (ferric sulfate).

In one embodiment, when the first transition metal is Cu, the Cu precursor may be selected from Cu(NO₃)₂ (copper(II) nitrate), CuSO₄·5H₂O (copper sulfate pentahydrate), CuCl₂·2H₂O (copper chloride dihydrate), Cu(CH₃COO)₂ (copper acetate), Cu(acac)₂ (copper acetylacetonate), CuBr₂ (copper bromide), or Cu(CO)₄ (copper carbonyl).

In one embodiment, when the first transition metal is Ir, the Ir precursor may be selected from IrCl₃·xH₂O (iridium trichloride hydrate), Ir(NO₃)₃ (iridium(III) nitrate), Ir(CO)₂Cl (iridium(III) dichlorocarbonyl), Ir(acac)₃ (iridium(III) acetylacetonate), IrBr₃ (iridium(III) bromide), IrI₃ (iridium(III) iodide), Ir(OH)₃ (iridium(III) hydroxide), Ir(CO)₄ (iridium(I) carbonyl), or IrCl₄ (iridium(IV) chloride).

In one embodiment, when the first transition metal is Pt, the Pt precursor may be selected from H₂PtCl₆·6H₂O (chloroplatinic acid hexahydrate), Pt(C₅H₇O₂)₂ (platinum acetylacetonate), PtCl₂ (platinum chloride), PtBr₂ (platinum bromide), PtI₂ (platinum iodide), Pt(NH₃)₂Cl₂ (cis-diamminedichloroplatinum), Na₂PtCl₆·6H₂O (sodium hexachloroplatinate hexahydrate), or K₂PtCl₆·6H₂O (potassium hexachloroplatinate hexahydrate).

In one embodiment, when the second transition metal is Pd, the Pd precursor may be selected from Pd(C₅H₇O₂)₂ (palladium acetylacetonate), PdCl₂ (palladium chloride), PdBr₂ (palladium bromide), PdI₂ (palladium iodide), K₂PdCl₄ (potassium chloropalladite), K₂PdCl₆ (palladium hexachloroplatinate), Pd(NO₃)₂·2H₂O (palladium nitrate dihydrate), Na₂PdCl₄·xH₂O (sodium tetrachloropalladate(II) hydrate), or Na₂PdCl₆·4H₂O (sodium hexachloropalladate(IV) tetrahydrate).

In one embodiment, when the second transition metal is Ni, the Ni precursor may be selected from Ni(NO₃)₂·6H₂O (nickel nitrate hexahydrate), NiCl₂·6H₂O (nickel chloride hexahydrate), NiSO₄·6H₂O (nickel sulfate hexahydrate), Ni(CH₃COO)₂·4H₂O (nickel acetate tetrahydrate), Ni(CO)₄ (nickel tetracarbonyl), Ni(OH)₂ (nickel hydroxide), or Ni(acac)₂ (nickel acetylacetonate).

In one embodiment, when the second transition metal is Co, the Co precursor may be selected from Co(NO₃)₂·6H₂O (cobaltous(II) nitrate hexahydrate), CoCl₂·6H₂O (cobalt(II) chloride hexahydrate), CoSO₄·7H₂O (cobalt(II) sulfate heptahydrate), Co(CH₃COO)₂·4H₂O (cobalt(II) acetate tetrahydrate), Co(acac)₂ (cobalt(II) acetylacetonate), CoBr₂ (cobalt(II) bromide), Co(OH)₂ (cobalt(II) hydroxide), or Co(CO)₄ (cobalt(I) carbonyl).

According to the present invention, when the carrier is the iron-nickel oxide (FeₓNi_{y}O_{z}), the Fe precursor for the carrier may be selected from FeCl₃ (ferric chloride), FeSO₄·7H₂O (ferrous sulfate heptahydrate), FeCl₂·4H₂O (ferrous chloride tetrahydrate), Fe(CH₃COO)₂ (ferrous acetate), Fe(CO)₅ (iron pentacarbonyl), or Fe₂(SO₄)₃ (ferric sulfate); the Ni precursor for the carrier may be selected from NiCl₂·6H₂O (nickel chloride hexahydrate), NiSO₄·6H₂O (nickel sulfate hexahydrate), Ni(CH₃COO)₂·4H₂O (nickel acetate tetrahydrate), Ni(CO)₄ (nickel tetracarbonyl), Ni(OH)₂ (nickel hydroxide), or Ni(acac)₂ (nickel acetylacetonate).

In one embodiment, the surfactant used in the preparation of the iron-nickel oxide (FeₓNi_{y}O_{z}) may be selected from Triton™ X-100 (polyethylene glycol tert-octylphenyl ether), Triton™ X-114 (polyethylene glycol n-dodecyl ether), Triton™ X-405 (polyethylene glycol nonylphenyl ether), Tween 20 (polysorbate 20), Tween 80 (polysorbate 80), Pluronic® F-127 (polyethylene glycol-polypropylene glycol block copolymer), Brij® 35 (polyoxyethylene lauryl ether), Myrj® 52 (polyoxyethylene sorbitan monolaurate), sorbitan esters (Span series), SDS (sodium dodecyl sulfate), CTAB (cetyltrimethylammonium bromide), Brij® 35 (polyoxyethylene lauryl ether), Span 80 (sorbitan monooleate), or dodecylbenzene sulfonic acid (DBSA).

According to the present invention, when the carrier is the silicon-aluminum oxide (AlₓSi_{y}O_{z}), the Al precursor for the carrier may be selected from Al(NO₃)₃·9H₂O (aluminum nitrate), Al(OC₃H₇)₃ (aluminum isopropoxide), Al₂(SO₄)₃ (aluminum sulfate), AlCl₃ (aluminum chloride), Al(OH)₃ (aluminum hydroxide), NaAlO₂ (sodium aluminium oxide), or Al(OC₄H₉)₃ (aluminum sec-butoxide); the Si precursor for the carrier may be selected from Si(OC₂H₅)₄ (tetraethyl orthosilicate, TEOS), SiO₂ (fumed silica, colloidal silica), Si(OH)₄ (silicic acid), Na₂SiO₃ (sodium metasilicate), or SiCl₄ (silicon tetrachloride).

In one embodiment, a template additive used in the preparation of the silicon-aluminum oxide (AlₓSi_{y}O_{z}) may be selected from [(C₃H₇)₄N]OH (tetra-n-propylammonium hydroxide, TPAH), N(CH₃)₄OH (tetramethylammonium hydroxide, TMAH), N(C₄H₉)₄OH (tetrabutylammonium hydroxide, TBAH), C₆H₁₂N₄ (hexamethylenetetramine, HMTA), C₂H₅NH₂ (ethylamine), (C₂H₅)₂NH (diethylamine), (C₂H₅)₃N (triethylamine), C₄H₉N (pyrrolidine), R₄N⁺X⁻ (quaternary ammonium salts, where R is an alkyl group and X is a halogen), or C₁₆H₃₃N(CH₃)₃Br (cetyltrimethylammonium bromide, CTAB).

According to the present invention, when the carrier is aluminium oxide (Al₂O₃), the carrier may be selected as commercial aluminium oxide with a BET specific surface area greater than 200 m²/g; the commercial aluminium oxide brand may be selected from Alfa Aesar, Sigma-Aldrich, or BASF.

According to the present invention, when the carrier is titanium dioxide (TiO₂), it may be selected as commercial titanium dioxide with a BET specific surface area greater than 50 m²/g; the commercial titanium dioxide brand may be selected from Chemours or Evonik.

In one embodiment, based on a total catalyst material weight of 100 wt %, the combined weight percentage of the first transition metal and the second transition metal may optionally be 0.2 wt %, 0.4 wt %, 0.6 wt %, 0.8 wt %, 1 wt %, 1.2 wt %, 1.4 wt %, 1.6 wt %, 1.8 wt %, 2 wt %, 2.2 wt %, 2.4 wt %, or 2.5 wt %; the combined weight percentage of the first transition metal and the second transition metal may be within any range formed by any two of the above values, but is not limited thereto.

In one embodiment, based on a total molar fraction of 100% for the second transition metal and the first transition metal, the molar ratio of the second transition metal to the first transition metal may optionally be 1:1, 1.1:1, 1.2:1, 1.3:1, 1.4:1, 1.5:1, 1.6:1, 1.7:1, 1.8:1, 1.9:1, or 2:1; the molar ratio of the second transition metal to the first transition metal may be within any range formed by any two of the above values, but is not limited thereto.

According to the present invention, the first transition metal and the second transition metal may both be single-atom metals.

In one embodiment, the sizes of the first transition metal and the second transition metal may each independently be from 0.2 nm to 3.0 nm. Optionally, the sizes of the first transition metal and the second transition metal may each independently be 0.2 nm, 0.4 nm, 0.6 nm, 0.8 nm, 1 nm, 1.2 nm, 1.4 nm, 1.6 nm, 1.8 nm, 2 nm, 2.2 nm, 2.4 nm, 2.6 nm, 2.8 nm, or 3 nm; the sizes of the first transition metal and the second transition metal may each independently be within any range formed by any two of the above values, but is not limited thereto.

In one embodiment, the size of the catalyst material may be ranging from 29 nm to 412 nm, and D₅₀ value may be ranging from 37.9 nm to 337.3 nm.

Optionally, the size of the catalyst material may be 29 nm, 30 nm, 90 nm, 120 nm, 150 nm, 180 nm, 210 nm, 240 nm, 270 nm, 300 nm, 330 nm, 360 nm, 390 nm, 400 nm, or 412 nm; the size of the catalyst material may be within any range formed by any two of the above values, but is not limited thereto.

Optionally, the D₅₀ value of the catalyst material size may be 37.9 nm, 40 nm, 70 nm, 100 nm, 130 nm, 160 nm, 190 nm, 220 nm, 250 nm, 280 nm, 310 nm, or 337.3 nm; the size of the catalyst material may be within any range formed by any two of the above values, but is not limited thereto.

In one embodiment, the BET specific surface area of the catalyst material may be ranging from 119.4 m²/g to 402.1 m²/g. Optionally, the BET specific surface area of the catalyst material may be 119.4 m²/g, 120 m²/g, 150 m²/g, 180 m²/g, 210 m²/g, 240 m²/g, 270 m²/g, 300 m²/g, 330 m²/g, 360 m²/g, 390 m²/g, or 402.1 m²/g; the BET specific surface area of the catalyst material may be within any range formed by any two of the above values, but is not limited thereto.

In one embodiment, the total pore volume of the catalyst material may be ranging from 0.19 cm³/g to 0.81 cm³/g. Optionally, the total pore volume of the catalyst material may be 0.19 cm³/g, 0.2 cm³/g, 0.3 cm³/g, 0.4 cm³/g, 0.5 cm³/g, 0.6 cm³/g, 0.7 cm³/g, 0.8 cm³/g, or 0.81 cm³/g; the total pore volume of the catalyst material may be within any range formed by any two of the above values, but is not limited thereto.

In one embodiment, the pore size of the catalyst material may be ranging from 9.2 nm to 47.2 nm. Optionally, the pore size of the catalyst material may be 9.2 nm, 10 nm, 15 nm, 20 nm, 25 nm, 30 nm, 35 nm, 40 nm, 45 nm, or 47.2 nm; the pore size of the catalyst material may be within any range formed by any two of the above values, but is not limited thereto.

Another objective of the present invention is to provide an application of the aforementioned catalyst material, wherein the catalyst material is added to a support material, such that the catalyst material and the support material together form a filter element for filtering airborne molecular contaminants (AMC), which is used for contacting and decomposing the airborne molecular contaminants.

According to the present invention, the catalyst material is added to the support material by impregnation, coating, mixing, or spraying techniques, such that the catalyst material and the support material together form a filter element for filtering airborne molecular contamination (AMC).

In one embodiment, the support material is prepared using the method disclosed in Taiwan Patent Publication No. TW202404683A, titled “Method For Manufacturing Airborne Molecular Contamination Filter.” In this embodiment, the support material is a fabric, prepared by immersing the fabric in a co-solvent containing the catalyst material, followed by drying to form the filter element; wherein, based on a total weight of 100 wt % of the filter element, the amount of catalyst material added to the fabric ranges from 0.1 wt % to 30 wt %. Specifically, the co-solvent may be a solvent containing ethanol.

In another embodiment, the support material is selected as a fabric formed from a fiber mixture using needle punch method; defining the fabric to have a filtering region and a flat region, wherein the flat region surrounds the filtering region, and the filtering region forms parallel linear corrugations through vacuum forming process, wherein the fiber mixture is selected from polyester fiber, nylon, rayon, hot-melt cotton, absorbent cotton, or a combination thereof.

In yet another embodiment, based on a total weight of 100 wt % of the filter element, the filter element is formed by uniformly mixing 70 wt % to 99.9 wt % of a polymer composition with 0.1 wt % to 30 wt % of the catalyst material, and then producing a nonwoven sheet-type filter element using melt blowing and spinning techniques. The polymer composition comprises at least a plastic material and a binder material, where the binder material functions to enhance processability during production and stability between heterogeneous materials (e.g., between the catalyst material and plastic material). The binder material may be polyvinyl alcohol, polyethylene oxide, polyvinyl acetate, ethylene-vinyl acetate copolymer, poly(acrylic acid) (PAA), or polyurethane, but is not limited thereto. The plastic material may be polyethylene, polypropylene, polyethylene terephthalate, polyethylene terephthalate glycol (PETG), cyclohexanedimethanol, or nylon, but is not limited thereto. Specifically, the melt blowing technique refers to extruding the uniformly mixed polymer composition and catalyst material through a nozzle surrounded by high-speed blowing gas and then spinning through a die head to form a nonwoven sheet-type filter element with the catalyst material randomly deposited. In other words, the support material is a nonwoven fabric formed from the polymer composition, with at least a portion of the catalyst material coated on the surface of the nonwoven fabric, allowing it to contact airborne molecular contaminants.

In one embodiment, based on a total weight of 100 wt % of the filter element, the filter element comprises 1.7 wt % to 28.3 wt % of the catalyst material, 0.1 wt % to 5 wt % of the binder material, and 66.7 wt % to 98 wt % of the plastic material.

In one embodiment, based on a total weight of 100 wt % of the filter element, the filter element comprises 4.8 wt % to 28.3 wt % of the catalyst material, 0.1 wt % to 5 wt % of the binder material, and 66.7 wt % to 95.1 wt % of the plastic material.

In one embodiment, based on a total weight of 100 wt % of the filter element, the amount of catalyst material added may be greater than 0 wt % and less than or equal to 30 wt %. In another embodiment, based on a total weight of 100 wt % for the catalyst material and the support material, the amount of catalyst material added may be 0.1 wt %, 0.5 wt %, 1.5 wt %, 2.5 wt %, 3.5 wt %, 4.8 wt %, 5.5 wt %, 6.5 wt %, 7.5 wt %, 8.5 wt %, 9.5 wt %, 10.5 wt %, 11.5 wt %, 12.5 wt %, 13.5 wt %, 14.5 wt %, 15.5 wt %, 16.5 wt %, 17.5 wt %, 18.5 wt %, 19.5 wt %, 20.5 wt %, 21.5 wt %, 22.5 wt %, 23.5 wt %, 24.5 wt %, 25.5 wt %, 26.5 wt %, 27.5 wt %, 28.3 wt %, or 30 wt %; the amount of catalyst material added may be within any range formed by any two of the above values, but is not limited thereto.

According to the present invention, the airborne molecular contamination comprises acetone, isopropanol (IPA), ethanol, ethyl acetate, toluene, xylene, trichloroethylene, propylene glycol monomethyl ether (PGME), propylene glycol monomethyl ether acetate (PGMEA), dimethyl sulfoxide (DMSO), or N-methyl-2-pyrrolidone (NMP). Specifically, the catalyst material of the present invention is particularly suitable for treating any of the airborne molecular contamination at a concentration ranging from 10 ppb to 5000 ppm; preferably, the catalyst material of the present invention is particularly suitable for treating any of the airborne molecular contamination at a concentration ranging from 10 ppb to 1000 ppm; more preferably, the catalyst material of the present invention is particularly suitable for treating any of the airborne molecular contamination at a concentration ranging from 500 ppb to 100 ppm.

According to the present invention, the catalyst material achieves a removal efficiency of 90.5% for the airborne molecular contaminants (AMC) at room temperature. In one embodiment, the removal efficiency of the catalyst material for the airborne molecular contaminants at room temperature ranges from 32.5% to 90.5%. Specifically, the removal efficiency of the catalyst material for the airborne molecular contaminants at room temperature may be 32.5%, 37.2%, 38.5%, 39.6%, 40.7%, 42.3%, 46.5%, 49.3%, 49.6%, 54.3%, 59.6%, 66.5%, 76.2%, or 90.5%; the removal efficiency may be within any range formed by any two of the above values, but is not limited thereto.

According to the present invention, the reaction temperature (T₉₀ value) for achieving a 90% removal efficiency of the airborne molecular contaminants with the catalyst material is less than or equal to 171.4° C. In one embodiment, the reaction temperature (T₉₀ value) for achieving a 90% removal efficiency of the airborne molecular contaminants with the catalyst material may be ranging from 25° C. to 171.4° C. (25° C.≤T₉₀≤171.4° C.). Specifically, the reaction temperature (T₉₀ value) for achieving a 90% removal efficiency of the airborne molecular contaminants with the catalyst material may be 25° C., 63.2° C., 82.1° C., 92.5° C., 99.5° C., 103.4° C., 117° C., 121° C., 133.2° C., 135° C., 151.2° C., 164.5° C., 167° C., or 171.4° C.; the reaction temperature may be within any range formed by any two of the above values, but is not limited thereto.

To achieve the above objectives, the techniques, methods, and other effects employed by the present invention are described in detail below with preferred feasible embodiments in conjunction with the drawings.

### BRIEF DESCRIPTION OF THE DRAWINGS

FIG. 1 is a TEM image of the loaded metal of the catalyst material in Example 1 of the present invention.

FIG. 2 is a TEM image of the loaded metal of the catalyst material in Example 3 of the present invention.

FIG. 3 is a TEM image of the loaded metal of the catalyst material in Example 7 of the present invention.

FIG. 4 is a bar graph showing the isopropanol (IPA) removal efficiency when the catalyst material in Example 4 of the present invention is added in different amounts to a fabric.

### DETAILED DESCRIPTION OF THE PREFERRED EMBODIMENTS

Below, several embodiments are provided to illustrate the embodiments of the catalyst material and its application according to the present invention. Those skilled in the art can easily understand the advantages and effects that can be achieved by the present invention through the contents of the following embodiments and comparative examples. It should be understood that the embodiments listed in this specification are provided for exemplary purposes only to illustrate the embodiments of the present invention, and are not intended to limit the scope of the present invention. Those skilled in the art can make various modifications and changes based on general knowledge without departing from the spirit of the present invention, in order to implement or apply the content of the present invention.

### Preparation of Catalyst Material

As shown in Table 1, the present invention provides catalyst materials for Examples 1 to 7 (E1 to E7) and Comparative Examples 1 to 9 (C1 to C9). Taking Example 1 (E1) as an illustration, the catalyst material is represented as “Pt₁Pd₁/FeₓNi_{y}O_{z},” where the part after “/” indicates the composition of the carrier of the catalyst material, such as “FeₓNi_{y}O_{z},” and the part before “/” indicates the composition of the loaded metal of the catalyst material, such as “Pt₁Pd₁.” Taking Example 6 (E6) as another illustration, the catalyst material is represented as “Pt/PdO/Al₂O₃,” where the part after the second “/” indicates the composition of the carrier of the catalyst material, such as “Al₂O₃,” and the part before the second “/” indicates the composition of the loaded metal of the catalyst material, such as “Pt/PdO.”

TABLE 1
Metal loading and TEM size of loaded metal for
catalyst materials in Examples 1 to 7 (E1 to
E7) and Comparative Examples 1 to 9 (C1 to C9).

| Sample | Catalyst Material | Metal Loading | TEM Size of |
|---|---|---|---|
| Code | (Loaded Metal/Carrier) | (wt %) | Loaded Metal (nm) |
| E1 | Pt₁Pd₁/FeₓNi_{y}O_{z} | 0.5 | 0.2-2 |
| C1 | Pt₁/FeₓNi_{y}O_{z} | 0.5 | 0.2-2 |
| C2 | Pd₁/FeₓNi_{y}O_{z} | 0.5 | 0.2-2 |
| E2 | Fe₁Pd₂/AlₓSi_{y}O_{z} | 0.5 | 0.2-2 |
| E3 | Cu₁Pd₂/AlₓSi_{y}O_{z} | 0.5 | 1.0-2.0 |
| E4 | Fe₁Ni₂/AlₓSi_{y}O_{z} | 0.5 | 0.2-2 |
| E5 | Fe₁Co₂/AlₓSi_{y}O_{z} | 0.5 | 0.2-2 |
| C3 | Cu₁/AlₓSi_{y}O_{z} | 0.5 | <1 |
| C4 | Pd₁/AlₓSi_{y}O_{z} | 0.5 | 0.2-2 |
| C5 | Fe₁Ni₂/AlₓSi_{y}O_{z} | 0.5 | 3.7-10.9 |
| C6 | Mn₁Co₂/AlₓSi_{y}O_{z} | 0.5 | 4.3-12.8 |
| E6 | Pt/PdO/Al₂O₃ | 0.2 | 2.0-3.0 |
| C7 | Pt/PdO/Al₂O₃ | 0.1 | 2.0-3.0 |
| E7 | Ir₁Pd₁/TiO₂ | 2.5 | 0.2-2 |
| C8 | Ir₁/TiO₂ | 2.5 | 0.2-2 |
| C9 | Pd₁/TiO₂ | 2.5 | 0.2-2 |

The preparation methods for the catalyst materials in Examples 1 to 7 (E1 to E7) and Comparative Examples 1 to 9 (C1 to C9) in Table 1 are described below.

Example 1 (E1): Preparation Method of Pt₁Pd₁/FeₓNi_{y}O_{z} The preparation steps of the FeₓNi_{y}O_{z} carrier included: weighing an appropriate amount of nickel nitrate hexahydrate (Ni(NO₃)₂·6H₂O, Sigma-Aldrich, 99.9%), iron nitrate nonahydrate (Fe(NO₃)₃·9H₂O, Sigma-Aldrich, 99.9%), and dissolving them in an appropriate amount of deionized water, wherein the weight ratio of nickel nitrate:iron nitrate:deionized water was 28.9:29.7:200, stirring for at least 30 minutes to form a mixed solution. Subsequently, titrating with a 2N potassium hydroxide (KOH, Sigma-Aldrich, 85% prepared) solution, while monitoring the redox potential of the mixed solution at −0.1783V; stirring the mixed solution at 500 rpm, 35° C. for 1 hour. Subsequently, separating the solid and liquid phases using a continuous centrifuge; after washing and drying, drying at 60° C. for one day; then calcining in a high-temperature furnace by raising the temperature from room temperature to 400° C. to 600° C. at a rate of 5° C./min, and holding at the calcination temperature for 12 hours to obtain FeₓNi_{y}O_{z} powder; the FeₓNi_{y}O_{z} powder consisting of FeNiO₃, FeNi₂O₄, Fe₂NiO₄, Fe₅NiO₈, or a mixed crystal phase thereof.

The preparation steps of the Pt₁Pd₁/FeₓNi_{y}O_{z} catalyst material included: adding the aforementioned FeₓNi_{y}O_{z} powder into an appropriate amount of deionized water, stirring at 500 rpm at 35° C. for 30 minutes to form an FeₓNi_{y}O_{z} aqueous solution. Subsequently, weighing an appropriate amount of Triton X-100 (Triton™ X-100, Sigma-Aldrich), chloroplatinic acid hexahydrate (H₂PtCl₆·6H₂O, Sigma-Aldrich, 99.9%), and potassium tetrachloropalladate (K₂PdCl₄, Sigma-Aldrich, 98%), and preparing them into stock solutions of 2.5 mM, 12.8 mM, and 23.5 mM, respectively, then sequentially adding them into the aforementioned FeₓNi_{y}O_{z} aqueous solution, continuing to stir for 30 minutes, raising the temperature at a rate of 5° C./min to 65° C.; when the temperature reaches 65° C., adding 45 mM sodium borohydride (NaBH₄, Sigma-Aldrich, 98%); observing the redox potential changes between 0.057 V and 0.065 V, then cooled to room temperature under a nitrogen atmosphere, followed by solid-liquid separation, and drying at 60° C. for one day to obtain the Pt₁Pd₁/FeₓNi_{y}O_{z} catalyst material of Example 1 (E1).

### Example 2 (E2): Preparation Method of Fe₁Pd₂/AlₓSi_{y}O_{z}

The preparation steps for the AlₓSi_{y}O_{z} carrier included: weighing an appropriate amount of aluminum nitrate nonahydrate (Al(NO₃)₃·9H₂O, Sigma-Aldrich, 98%), sodium metasilicate (Na₂SiO₃, Sigma-Aldrich, 95%), tetra-n-propylammonium hydroxide (TPAH, Sigma-Aldrich, 99%), and dissolving them in an appropriate amount of deionized water to form a mixed solution, wherein the weight ratio of aluminum nitrate:sodium metasilicate:TPAH:deionized water was 55.62:26.07:5:200. The mixed solution was stirred for at least 30 minutes, then transferred to a high-pressure reactor, and the temperature was increased at a rate of 5° C./min to 155° C. and maintained for 6 hours. The solid and liquid phases were then separated using a continuous centrifuge, washed with water, and dried at 60° C. for one day to form a mixture.

Subsequently, the mixture was calcined in a high-temperature furnace by raising the temperature from room temperature to 450° C. to 550° C. at a rate of 5° C./min and holding the calcination temperature for 12 hours to obtain AlₓSi_{y}O_{z} powder. The AlₓSi_{y}O_{z} powder may consist of AlSiO₃, AlSi₂O₆, AlSi₃O₈, AlSi₄O₁₀, Al₂SiO₅, Al₂SiO₆, Al₂Si₂O₆, Al₂Si₂O₇, Al₂Si₂O₉, or a mixed crystal phase thereof.

The preparation steps for the FePd₂/AlₓSi_{y}O_{z} catalyst material included: adding the aforementioned AlₓSi_{y}O_{z} powder into an appropriate amount of deionized water, stirring at 500 rpm at 35° C. for 30 minutes to form an AlₓSi_{y}O_{z} aqueous solution. Subsequently, an appropriate amount of Triton™ X-100 (Sigma-Aldrich), iron nitrate nonahydrate (Fe(NO₃)₃·9H₂O, Sigma-Aldrich, 99.9%), and potassium chloropalladite (K₂PdCl₄, Sigma-Aldrich, 98%) were weighed and prepared into stock solutions of 2.5 mM, 16.43 mM, and 23.5 mM, respectively. These stock solutions were then sequentially added to the AlₓSi_{y}O_{z} aqueous solution to form a mixture, and the mixture was stirred continuously for 30 minutes. The temperature was then increased at a rate of 5° C./min to 65° C. When the temperature reached 65° C., 45 mM sodium borohydride (NaBH₄, Sigma-Aldrich, 98%) was added. After observing the redox potential changes between 0.057 V and 0.0981 V, the mixture was cooled to room temperature under a nitrogen atmosphere, followed by solid-liquid separation to form a resulting material. The resulting material was dried at 60° C. for one day to obtain the Fe₁Pd₂/AlₓSi_{y}O_{z} catalyst material of Example 2 (E2).

### Example 3 (E3): Preparation Method of CuIPd₂/AlₓSi_{y}O_{z}

The preparation steps for the AlₓSi_{y}O_{z} carrier were the same as those for the AlₓSi_{y}O_{z} carrier in Example 2 (E2) to obtain AlₓSi_{y}O_{z} powder. The AlₓSi_{y}O_{z} powder could consist of AlSiO₃, AlSi₂O₆, AlSi₃O₈, AlSi₄O₁₀, Al₂SiO₅, Al₂SiO₆, Al₂Si₂O₆, Al₂Si₂O₇, Al₂Si₂O₉, or a mixed crystal phase thereof.

The preparation steps for the Cu₁Pd₂/AlₓSi_{y}O_{z} catalyst material included: adding the aforementioned AlₓSi_{y}O_{z} powder into an appropriate amount of deionized water, stirring at 500 rpm at 35° C. for 30 minutes to form an AlₓSi_{y}O_{z} aqueous solution. Subsequently, an appropriate amount of Triton™ X-100 (Sigma-Aldrich), copper(II) nitrate trihydrate (Cu(NO₃)₂·3H₂O, Sigma-Aldrich, 98%), and potassium chloropalladite (K₂PdCl₄, Sigma-Aldrich, 98%) were weighed and prepared into stock solutions of 2.5 mM, 74.88 mM, and 23.5 mM, respectively. These stock solutions were then sequentially added to the AlₓSi_{y}O_{z} aqueous solution to form a mixture, and the mixture was stirred continuously for 30 minutes. The temperature was then increased at a rate of 5° C./min to 65° C. When the temperature reached 65° C., 45 mM sodium borohydride (NaBH₄, Sigma-Aldrich, 98%) was added. After observing the redox potential changes between 0.057 V and 0.0981 V, the mixture was cooled to room temperature under a nitrogen atmosphere, followed by solid-liquid separation to form a resulting material. The resulting material was dried at 60° C. for one day to obtain the Cu₁Pd₂/AlₓSi_{y}O_{z} catalyst material of Example 3 (E3).

### Example 4 (E4): Preparation Method of Fe₁Ni₂/AlₓSi_{y}O_{z}

The preparation steps for the AlₓSi_{y}O_{z} carrier were the same as those for the AlₓSi_{y}O_{z} carrier in Example 2 (E2) to obtain AlₓSi_{y}O_{z} powder. The AlₓSi_{y}O_{z} powder could consist of AlSiO₃, AlSi₂O₆, AlSi₃O₈, AlSi₄O₁₀, Al₂SiO₅, Al₂SiO₆, Al₂Si₂O₆, Al₂Si₂O₇, Al₂Si₂O₉, or a mixed crystal phase thereof.

The preparation steps for the Fe₁Ni₂/AlₓSi_{y}O_{z} catalyst material included: adding the AlₓSi_{y}O_{z} powder into an appropriate amount of deionized water, stirring at 500 rpm at 35° C. for 30 minutes to form an AlₓSi_{y}O_{z} aqueous solution. Subsequently, an appropriate amount of Triton™ X-100 (Sigma-Aldrich), iron nitrate nonahydrate (Fe(NO₃)₃·9H₂O, Sigma-Aldrich, 99.9%), and nickel nitrate hexahydrate (Ni(NO₃)₂·6H₂O, Sigma-Aldrich, 99.9%) were weighed and prepared into stock solutions of 2.5 mM, 44.77 mM, and 42.60 mM, respectively. These stock solutions were then sequentially added to the AlₓSi_{y}O_{z} aqueous solution to form a mixture, and the mixture was stirred continuously for 30 minutes. The temperature was then increased at a rate of 5° C./min to 65° C. When the temperature reached 65° C., 45 mM sodium borohydride (NaBH₄, Sigma-Aldrich, 98%) was added. After observing the redox potential changes between 0.057 V and 0.0981 V, the mixture was cooled to room temperature under a nitrogen atmosphere, followed by solid-liquid separation to form a resulting material. The resulting material was dried at 60° C. for one day to obtain the Fe₁Ni₂/AlₓSi_{y}O_{z} catalyst material of Example 4 (E4).

### Example 5 (E5): Preparation Method of Fe₁Co₂/AlₓSi_{y}O_{z}

The preparation steps for the AlₓSi_{y}O_{z} carrier were the same as those for the AlₓSi_{y}O_{z} carrier in Example 2 (E2) to obtain AlₓSi_{y}O_{z} powder. The AlₓSi_{y}O_{z} powder could consist of AlSiO₃, AlSi₂O₆, AlSi₃O₈, AlSi₄O₁₀, Al₂SiO₅, Al₂SiO₆, Al₂Si₂O₆, Al₂Si₂O₇, Al₂Si₂O₉, or a mixed crystal phase thereof.

The preparation steps for the Fe₁Co₂/AlₓSi_{y}O_{z} catalyst material included: adding the AlₓSi_{y}O_{z} powder into an appropriate amount of deionized water, stirring at 500 rpm at 35° C. for 30 minutes to form an AlₓSi_{y}O_{z} aqueous solution. Subsequently, an appropriate amount of Triton™ X-100 (Sigma-Aldrich), iron nitrate nonahydrate (Fe(NO₃)₃·9H₂O, Sigma-Aldrich, 99.9%), and cobaltous nitrate hexahydrate (Co(NO₃)₂·6H₂O, Sigma-Aldrich, 99.9%) were weighed and prepared into stock solutions of 2.5 mM, 44.77 mM, and 42.42 mM, respectively. These stock solutions were then sequentially added to the AlₓSi_{y}O_{z} aqueous solution to form a mixture, and the mixture was stirred continuously for 30 minutes. The temperature was then increased at a rate of 5° C./min to 65° C. When the temperature reached 65° C., 45 mM sodium borohydride (NaBH₄, Sigma-Aldrich, 98%) was added. After observing the redox potential changes between 0.057 V and 0.0981 V, the mixture was cooled to room temperature under a nitrogen atmosphere, followed by solid-liquid separation to form a resulting material. The resulting material was dried at 60° C. for one day to obtain the Fe₁Co₂/AlₓSi_{y}O_{z} catalyst material of Example 5 (E5).

### Example 6 (E6): Preparation Method of Pt/PdO/Al₂O₃

The Al₂O₃ carrier used commercial aluminum oxide (Al₂O₃) powder (Alfa Aesar, BET>200 m²/g).

The preparation steps for the Pt/PdO/Al₂O₃ catalyst material included: adding the aforementioned Al₂O₃ powder into an appropriate amount of deionized water, stirring at 500 rpm at 35° C. for 30 minutes to form an Al₂O₃ aqueous solution. Subsequently, an appropriate amount of Triton™ X-100 (Sigma-Aldrich), chloroplatinic acid hexahydrate (H₂PtCl₆·6H₂O, Sigma-Aldrich, 99.9%), and potassium chloropalladite (K₂PdCl₄, Sigma-Aldrich, 98%) were weighed and prepared into stock solutions of 2.5 mM, 12.8 mM, and 23.5 mM, respectively. These stock solutions were then sequentially added to the Al₂O₃ aqueous solution to form a mixture, and the mixture was stirred continuously for 30 minutes. The temperature was then increased at a rate of 5° C./min to 65° C. When the temperature reached 65° C., 45 mM sodium borohydride (NaBH₄, Sigma-Aldrich, 98%) was added. After observing the redox potential changes between 0.057 V and 0.065 V, the mixture was cooled to room temperature under a nitrogen atmosphere, followed by solid-liquid separation to form a resulting material. The resulting material was dried at 60° C. for one day to obtain the Pt/PdO/Al₂O₃ catalyst material of Example 6 (E6).

### Example 7 (E7): Preparation Method of Ir₁Pd₁/TiO₂

The TiO₂ carrier used commercial titanium dioxide (TiO₂) powder (Chemours, BET>50 m²/g).

The preparation steps for the Ir₁Pd₁/TiO₂ catalyst material included: adding the aforementioned TiO₂ powder into an appropriate amount of deionized water/alcohol (weight ratio of 1:1) mixture, stirring at 500 rpm at 30° C. for 30 minutes to form a TiO₂ aqueous solution. Subsequently, an appropriate amount of Triton™ X-100 (Sigma-Aldrich), iridium(iii) chloride hydrate (IrCl₃·xH₂O, Sigma-Aldrich, 99.9%), and potassium chloropalladite (K₂PdCl₄, Sigma-Aldrich, 98%) were weighed and prepared into stock solutions of 2.5 mM, 13.1 mM, and 23.5 mM, respectively. These stock solutions were then sequentially added to the TiO₂ aqueous solution to form a mixture, and the mixture was stirred continuously for 30 minutes. The temperature was then increased at a rate of 5° C./min to 85° C. When the temperature reached 85° C., 80 mM urea (Sigma-Aldrich, 99.5%) was added. After observing the redox potential changes between 0.057 V and 0.065 V, the mixture was cooled to room temperature under a nitrogen atmosphere, followed by solid-liquid separation to form a resulting material. The resulting material was dried at 60° C. for one day to obtain the Ir₁Pd₁/TiO₂ catalyst material of Example 7 (E7).

### Comparative Example 1 (C1): Preparation Method of Pt₁/FeₓNi_{y}O_{z}

The preparation steps for the FeₓNi_{y}O_{z} carrier were the same as those for the FeₓNi_{y}O_{z} carrier in Example 1 (E1) to obtain FeₓNi_{y}O_{z} powder. The FeₓNi_{y}O_{z} powder could consist of FeNiO₃, FeNi₂O₄, Fe₂NiO₄, Fe₅NiO₈, or a mixed crystal phase thereof.

The preparation steps for the Pt₁/FeₓNi_{y}O_{z} catalyst material included: adding the aforementioned FeₓNi_{y}O_{z} powder into an appropriate amount of deionized water, stirring at 500 rpm at 35° C. for 30 minutes to form an FeₓNi_{y}O_{z} aqueous solution. Subsequently, an appropriate amount of Triton™ X-100 (Sigma-Aldrich) and chloroplatinic acid hexahydrate (H₂PtCl₆·6H₂O, Sigma-Aldrich, 99.9%) were weighed and prepared into stock solutions of 2.5 mM and 12.8 mM, respectively. These stock solutions were then sequentially added to the FeₓNi_{y}O_{z} aqueous solution to form a mixture, and the mixture was stirred continuously for 30 minutes. The temperature was then increased at a rate of 5° C./min to 65° C. When the temperature reached 65° C., 45 mM sodium borohydride (NaBH₄, Sigma-Aldrich, 98%) was added. After observing the redox potential changes between 0.35 V and 0.36 V, the mixture was cooled to room temperature under a nitrogen atmosphere, followed by solid-liquid separation to form a resulting material. The resulting material was dried at 60° C. for one day.

### Comparative Example 2 (C2): Preparation Method of Pd₁/FeₓNi_{y}O_{z}

The preparation steps for the FeₓNi_{y}O_{z} carrier were the same as those for the FeₓNi_{y}O_{z} carrier in Example 1 (E1) to obtain FeₓNi_{y}O_{z} powder. The FeₓNi_{y}O_{z} powder could consist of FeNiO₃, FeNi₂O₄, Fe₂NiO₄, Fe₅NiO₈, or a mixed crystal phase thereof.

The preparation steps for the Pd₁/FeₓNi_{y}O_{z} catalyst material included: adding the aforementioned FeₓNi_{y}O_{z} powder into an appropriate amount of deionized water, stirring at 500 rpm at 35° C. for 30 minutes to form an FeₓNi_{y}O_{z} aqueous solution. Subsequently, an appropriate amount of Triton™ X-100 (Sigma-Aldrich) and potassium chloropalladite (K₂PdCl₄, Sigma-Aldrich, 98%) were weighed and prepared into stock solutions of 2.5 mM and 23.5 mM, respectively. These stock solutions were then sequentially added to the FeₓNi_{y}O_{z} aqueous solution to form a mixture, and the mixture was stirred continuously for 30 minutes. The temperature was then increased at a rate of 5° C./min to 65° C. When the temperature reached 65° C., 45 mM sodium borohydride (NaBH₄, Sigma-Aldrich, 98%) was added. After observing the redox potential changes between 0.32 V and 0.33 V, the mixture was cooled to room temperature under a nitrogen atmosphere, followed by solid-liquid separation to form a resulting material. The resulting material was dried at 60° C. for one day.

### Comparative Example 3 (C3): Preparation Method of Cu₁/AlₓSi_{y}O_{z}

The preparation steps for the AlₓSi_{y}O_{z} carrier were the same as those for the AlₓSi_{y}O_{z} carrier in Example 2 (E2) to obtain AlₓSi_{y}O_{z} powder. The AlₓSi_{y}O_{z} powder could consist of AlSiO₃, AlSi₂O₆, AlSi₃O₈, AlSi₄O₁₀, Al₂SiO₅, Al₂SiO₆, Al₂Si₂O₆, Al₂Si₂O₇, Al₂Si₂O₉, or a mixed crystal phase thereof.

The preparation steps for the Cu₁/AlₓSi_{y}O_{z} catalyst material included: adding the AlₓSi_{y}O_{z} powder into an appropriate amount of deionized water, stirring at 500 rpm at 35° C. for 30 minutes to form an AlₓSi_{y}O_{z} aqueous solution. Subsequently, an appropriate amount of Triton™ X-100 (Sigma-Aldrich) and copper(II) nitrate trihydrate (Cu(NO₃)₂·3H₂O, Sigma-Aldrich, 98%) were weighed and prepared into stock solutions of 2.5 mM and 74.88 mM, respectively. These stock solutions were then sequentially added to the AlₓSi_{y}O_{z} aqueous solution to form a mixture, and the mixture was stirred continuously for 30 minutes. The temperature was then increased at a rate of 5° C./min to 65° C. When the temperature reached 65° C., 45 mM sodium borohydride (NaBH₄, Sigma-Aldrich, 98%) was added. After observing the redox potential changes between 0.35 V and 0.37 V, the mixture was cooled to room temperature under a nitrogen atmosphere, followed by solid-liquid separation to form a resulting material. The resulting material was dried at 60° C. for one day.

### Comparative Example 4 (C4): Preparation Method of Pd₁/AlₓSi_{y}O_{z}

The preparation steps for the AlₓSi_{y}O_{z} carrier were the same as those for the AlₓSi_{y}O_{z} carrier in Example 2 (E2) to obtain AlₓSi_{y}O_{z} powder. The AlₓSi_{y}O_{z} powder could consist of AlSiO₃, AlSi₂O₆, AlSi₃O₈, AlSi₄O₁₀, Al₂SiO₅, Al₂SiO₆, Al₂Si₂O₆, Al₂Si₂O₇, Al₂Si₂O₉, or a mixed crystal phase thereof.

The preparation steps for the Pd₁/AlₓSi_{y}O_{z} catalyst material included: adding the aforementioned AlₓSi_{y}O_{z} powder into an appropriate amount of deionized water, stirring at 500 rpm at 35° C. for 30 minutes to form an AlₓSi_{y}O_{z} aqueous solution. Subsequently, an appropriate amount of Triton™ X-100 (Sigma-Aldrich) and potassium chloropalladite (K₂PdCl₄, Sigma-Aldrich, 98%) were weighed and prepared into stock solutions of 2.5 mM and 23.5 mM, respectively. These stock solutions were then sequentially added to the AlₓSi_{y}O_{z} aqueous solution to form a mixture, and the mixture was stirred continuously for 30 minutes. The temperature was then increased at a rate of 5° C./min to 65° C. When the temperature reached 65° C., 45 mM sodium borohydride (NaBH₄, Sigma-Aldrich, 98%) was added. After observing the redox potential changes between 0.40 V and 0.41 V, the mixture was cooled to room temperature under a nitrogen atmosphere, followed by solid-liquid separation to form a resulting material. The resulting material was dried at 60° C. for one day.

### Comparative Example 5 (C5): Preparation Method of Fe₁Ni₂/AlₓSi_{y}O_{z}

The preparation steps for the AlₓSi_{y}O_{z} carrier were the same as those for the AlₓSi_{y}O_{z} carrier in Example 2 (E2) to obtain AlₓSi_{y}O_{z} powder. The AlₓSi_{y}O_{z} powder could consist of AlSiO₃, AlSi₂O₆, AlSi₃O₈, AlSi₄O₁₀, Al₂SiO₅, Al₂SiO₆, Al₂Si₂O₆, Al₂Si₂O₇, Al₂Si₂O₉, or a mixed crystal phase thereof.

The preparation steps for the Fe₁Ni₂/AlₓSi_{y}O_{z} catalyst material included: adding the aforementioned AlₓSi_{y}O_{z} powder into an appropriate amount of deionized water, stirring at 500 rpm at 35° C. for 30 minutes to form an AlₓSi_{y}O_{z} aqueous solution. Subsequently, an appropriate amount of Triton™ X-100 (Sigma-Aldrich), iron nitrate nonahydrate (Fe(NO₃)₃·9H₂O, Sigma-Aldrich, 99.9%), and nickel nitrate hexahydrate (Ni(NO₃)₂·6H₂O, Sigma-Aldrich, 99.9%) were weighed and prepared into stock solutions of 7.5 mM, 134.3 mM, and 42.60 mM, respectively. These stock solutions were then sequentially added to the AlₓSi_{y}O_{z} aqueous solution to form a mixture, and the mixture was stirred continuously for 30 minutes. The temperature was then increased at a rate of 5° C./min to 65° C. When the temperature reached 65° C., 45 mM sodium borohydride (NaBH₄, Sigma-Aldrich, 98%) was added. After observing the redox potential changes between 0.45 V and 0.46 V, the mixture was cooled to room temperature under a nitrogen atmosphere, followed by solid-liquid separation to form a resulting material. The resulting material was dried at 60° C. for one day.

### Comparative Example 6 (C6): Preparation Method of Mn₁Co₂/AlₓSi_{y}O_{z}

The preparation steps for the AlₓSi_{y}O_{z} carrier were the same as those for the AlₓSi_{y}O_{z} carrier in Example 2 (E2) to obtain AlₓSi_{y}O_{z} powder. The AlₓSi_{y}O_{z} powder could consist of AlSiO₃, AlSi₂O₆, AlSi₃O₈, AlSi₄O₁₀, Al₂SiO₅, Al₂SiO₆, Al₂Si₂O₆, Al₂Si₂O₇, Al₂Si₂O₉, or a mixed crystal phase thereof.

The preparation steps for the Mn₁Co₂/AlₓSi_{y}O_{z} catalyst material included: adding the aforementioned AlₓSi_{y}O_{z} powder into an appropriate amount of deionized water, stirring at 500 rpm at 35° C. for 30 minutes to form an AlₓSi_{y}O_{z} aqueous solution. Subsequently, an appropriate amount of Triton™ X-100 (Sigma-Aldrich), manganese nitrate hydrate (Mn(NO₃)₂·4H₂O, Sigma-Aldrich, 99%), and cobaltous nitrate hexahydrate (Co(NO₃)₂·6H₂O, Alfa, 98%) were weighed and prepared into stock solutions of 7.5 mM, 100.4 mM, and 100.6 mM, respectively. These stock solutions were then sequentially added to the AlₓSi_{y}O_{z} aqueous solution, and the mixture was stirred continuously for 30 minutes. The temperature was then increased at a rate of 5° C./min to 65° C. When the temperature reached 65° C., 45 mM sodium borohydride (NaBH₄, Sigma-Aldrich, 98%) was added. After observing the redox potential changes between 0.41 V and 0.42 V, the mixture was cooled to room temperature under a nitrogen atmosphere, followed by solid-liquid separation to form a resulting material. The resulting material was dried at 60° C. for one day.

### Comparative Example 7 (C7): Preparation Method of Pt/PdO/Al₂O₃

The Al₂O₃ carrier used commercial aluminum oxide (Al₂O₃) powder (Alfa Aesar, BET>200 m²/g).

The preparation steps for the Pt/PdO/Al₂O₃ catalyst material included: adding the aforementioned Al₂O₃ powder into an appropriate amount of deionized water, stirring at 500 rpm at 35° C. for 30 minutes to form an Al₂O₃ aqueous solution. Subsequently, an appropriate amount of Triton™ X-100 (Sigma-Aldrich), chloroplatinic acid hexahydrate (H₂PtCl₆·6H₂O, Sigma-Aldrich, 99.9%), and potassium chloropalladite (K₂PdCl₄, Sigma-Aldrich, 98%) were weighed and prepared into stock solutions of 2.5 mM, 6.4 mM, and 23.5 mM, respectively. These stock solutions were then sequentially added to the Al₂O₃ aqueous solution to form a mixture, and the mixture was stirred continuously for 30 minutes. The temperature was then increased at a rate of 5° C./min to 65° C. When the temperature reached 65° C., 45 mM sodium borohydride (NaBH₄, Sigma-Aldrich, 98%) was added. After observing the redox potential changes between 0.45 V and 0.46 V, the mixture was cooled to room temperature under a nitrogen atmosphere, followed by solid-liquid separation to form a resulting material. The resulting material was dried at 60° C. for one day.

### Comparative Example 8 (C8): Preparation Method of Ir₁/TiO₂

The TiO₂ carrier used commercial titanium dioxide (TiO₂) powder (Chemours, BET>50 m²/g).

The preparation steps for the Ir₁/TiO₂ catalyst material included: adding the aforementioned TiO₂ powder into an appropriate amount of deionized water/alcohol (weight ratio of 1:1) mixture, stirring at 500 rpm at 30° C. for 30 minutes to form a TiO₂ aqueous solution. Subsequently, an appropriate amount of Triton™ X-100 (Sigma-Aldrich) and iridium trichloride hydrate (IrCl₃·xH₂O, Sigma-Aldrich, 99.9%) were weighed and prepared into stock solutions of 2.5 mM and 13.1 mM, respectively. These stock solutions were then sequentially added to the TiO₂ aqueous solution to form a mixture, and the mixture was stirred continuously for 30 minutes. The temperature was then increased at a rate of 5° C./min to 85° C. When the temperature reached 85° C., 80 mM urea (Urea, Sigma-Aldrich, 99.5%) was added. After observing the redox potential changes between 0.29 V and 0.30 V, the mixture was cooled to room temperature under a nitrogen atmosphere, followed by solid-liquid separation to form a resulting material. The resulting material was dried at 60° C. for one day.

### Comparative Example 9 (C9): Preparation Method of Pd₁/TiO₂

The TiO₂ carrier used commercial titanium dioxide (TiO₂) powder (Chemours, BET>50 m²/g).

The preparation steps for the Pd₁/TiO₂ catalyst material included: adding the aforementioned TiO₂ powder into an appropriate amount of deionized water/alcohol (weight ratio of 1:1) mixture, stirring at 500 rpm at 30° C. for 30 minutes to form a TiO₂ aqueous solution. Subsequently, an appropriate amount of Triton™ X-100 (Sigma-Aldrich) and potassium chloropalladite (K₂PdCl₄, Sigma-Aldrich, 98%) were weighed and prepared into stock solutions of 2.5 mM and 23.5 mM, respectively. These stock solutions were then sequentially added to the TiO₂ aqueous solution to form a mixture, and the mixture was stirred continuously for 30 minutes. The temperature was then increased at a rate of 5° C./min to 85° C. When the temperature reached 85° C., 80 mM urea (Urea, Sigma-Aldrich, 99.5%) was added. After observing the redox potential changes between 0.29 V and 0.30 V, the mixture was cooled to room temperature under a nitrogen atmosphere, followed by solid-liquid separation to form a resulting material. The resulting material was dried at 60° C. for one day.

### Detection of Catalyst Material

As shown in Table 1, for Examples 1 to 7, under the conditions involving two types of transition metals, the TEM images obtained by transmission electron microscopy (TEM) showed that the particle sizes of the loaded metals in Examples 1 to 5 and 7 (E1 to E5, E7) were all less than 2 nm, with the smallest size being only 0.2 nm, and the largest loaded metal size reaching only 3 nm (E6). Compared to the comparative examples (C1 to C4, C8, C9) which contained only a single type of transition metal, the catalyst materials in Examples 1 to 7 of the present invention demonstrated a significant synergistic effect due to the presence of bimetallic systems. Relative to comparative examples containing two types of transition metals (C5, C6), Examples 1 to 7 had smaller TEM particle sizes for the loaded metals, which provided higher density of active sites, enhanced catalyst activity, larger surface area, better reaction selectivity, and improved stability.

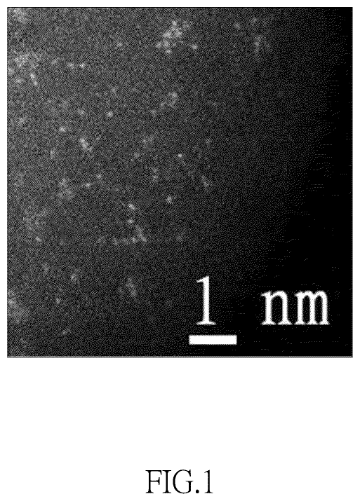

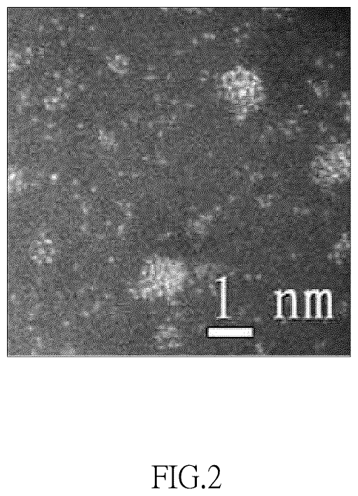

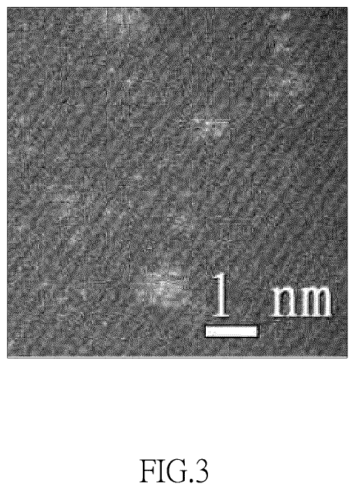

As shown in FIGS. 1 to 3, the TEM images of Examples 1, 3, and 7 of the present invention are presented. As seen in FIG. 1, the distribution of the loaded metal particles in Example 1 was relatively uniform, with particle sizes ranging from approximately 0.2 nm to 2 nm, consistent with the data in Table 1. The particles in FIG. 1 were relatively dispersed, which indicated that the distribution of Pt and Pd on the FeₓNi_{y}O_{z} surface was relatively uniform, contributing to enhanced catalytic activity. Moreover, the small particles contributed to an increased specific surface area and catalytic activity, thereby providing synergistic effects in the bimetallic catalyst and enhancing the overall reaction efficiency. In FIG. 2, some larger particles, ranging from about 1.0 nm to 2.0 nm, were observed in the loaded metal particles of Example 3, which was consistent with the TEM size description in Table 1. These particles formed distinct dotted distributions on the substrate, indicating the presence of bimetallic particles. Additionally, the synergistic effect of bimetallic Cu—Pd helped enhance the catalytic selectivity and activity for specific reactions. Unlike Example 1, the loaded metal particles in Example 3 were slightly larger, but still within a small range, contributing to high catalytic efficiency. FIG. 3 showed that the loaded metal particles in Example 7 had a relatively fine distribution, with particle sizes ranging from approximately 0.2 nm to 2 nm, consistent with the data in Table 1. The particles on TiO₂ were uniformly distributed and small in size, indicating good dispersion of Ir—Pd particles, which was highly beneficial for enhancing catalytic performance. Moreover, the good distribution of the Ir—Pd bimetallic system on the TiO₂ carrier could improve the catalyst's stability and reaction activity, especially for applications requiring high stability and long service life.

As shown in Table 2, the measurement results of particle size, D₅₀ value, specific surface area, total pore volume, and pore size parameters of the catalyst materials in Table 1 are presented.

The particle size of the catalyst material was measured using a particle size analyzer, and it was found that the particle sizes of the bimetallic catalyst materials in Examples 1 to 7 (E1 to E7) were generally within a smaller range. For instance, the particle size of E1 ranged from 30 nm to 61 nm. In comparison to the single-metal catalyst of comparative examples, such as C1 (29 nm to 62 nm) or C2 (33 nm to 66 nm), the particle size of E1 was significantly smaller. Smaller particle sizes provided more surface-active sites, facilitating easier contact between reactants and active surface, thereby promoting the reaction, and effectively enhancing the catalytic activity. In addition, the D₅₀ value, which represented the median particle size, was generally smaller for E1 to E7 compared to comparative examples C1 to C9. This indicated that the particle size distribution of the bimetallic catalyst materials in E1 to E7 was more concentrated and uniform. For instance, the D₅₀ value of E1 was 47.5 nm, which was smaller than that of C1 (47.7 nm) and C2 (49.9 nm). Since smaller particles provided a larger surface area and more active sites, catalysts with a smaller D₅₀ value, like E1 to E7, exhibited higher activity and stability.

In terms of specific surface area, Examples 1 to 7 (E1 to E7) generally exhibited larger specific surface areas compared to the corresponding comparative examples (C1 to C9). For example, the specific surface area of E4 was 402.1 m²/g, compared to C5, which had 339.4 m²/g. Examples 1 to 7 had sufficiently large surface areas, which could provide ample active surfaces to promote the reaction, facilitating an increase in reaction rate and efficiency.

In terms of total pore volume, Examples 1 to 7 (E1 to E7) generally exhibited smaller pore volumes compared to the corresponding comparative examples C1 to C9. For instance, the total pore volume of E1 was 0.37 cm³/g, compared to C1 at 0.39 cm³/g and C2 at 0.38 cm³/g. The pore volumes of Examples 1 to 7 were slightly lower. However, despite a smaller total pore volume, the pore structure and size were likely to positively influence the catalytic performance.

In terms of pore size, Examples 1 to 7 (E1 to E7) generally exhibited smaller pore sizes compared to the corresponding comparative examples C1 to C9. For instance, the pore size of E3 was 9.2 nm, compared to C3 at 14.9 nm and C4 at 14.7 nm. This showed that bimetallic catalyst materials could better promote molecular diffusion and enhance catalytic performance.

Overall, the bimetallic catalyst materials in examples E1 to E7 had smaller particle sizes compared to those in comparative examples C1 to C9, providing more surface-active sites to promote the reaction and enhance catalytic activity. They also exhibited an appropriate specific surface area and pore size to provide favorable molecular diffusion conditions, thus improving the overall performance of the catalyst. Furthermore, a smaller D₅₀ value indicated a more concentrated and uniform particle size distribution, which contributed to stable reactions and enhanced selectivity. Compared to C1 to C9, the bimetallic catalyst materials in E1 to E7 exhibited significant synergistic effects, enhancing reaction activity, selectivity, and stability, resulting in notable advantages.

TABLE 2
Size, D₅₀ value, specific surface area, total pore volume, and pore
size of catalyst materials in Examples 1 to 7 (E1 to E7)
and Comparative Examples 1 to 9 (C1 to C9).

| | | Catalyst | | Specific | Total | |
|---|---|---|---|---|---|---|
| | | Material | D₅₀ | Surface | Pore | Pore |
| Sample | Catalyst | Size | Value | Area | Volume | Size |
| Code | Material | (nm) | (nm) | (m²/g) | (cm³/g) | (nm) |
| E1 | Pt₁Pd₁/FeₓNi_{y}O_{z} | 30~61 | 47.5 | 119.4 | 0.37 | 47.2 |
| C1 | Pt₁/FeₓNi_{y}O_{z} | 29~62 | 47.7 | 123.9 | 0.39 | 48.2 |
| C2 | Pd₁/FeₓNi_{y}O_{z} | 33~66 | 49.9 | 131.2 | 0.38 | 46.1 |
| E2 | Fe₁Pd₂/AlₓSi_{y}O_{z} | 202~350 | 297.3 | 363.2 | 0.64 | 11.3 |
| E3 | Cu₁Pd₂/AlₓSi_{y}O_{z} | 252~412 | 337.3 | 382.6 | 0.72 | 9.2 |
| E4 | Fe₁Ni₂/AlₓSi_{y}O_{z} | 192~382 | 263.5 | 402.1 | 0.53 | 12.6 |
| E5 | Fe₁Co₂/AlₓSi_{y}O_{z} | 195~402 | 303.9 | 348.7 | 0.81 | 15.2 |
| C3 | Cu₁/AlₓSi_{y}O_{z} | 188~393 | 298.8 | 361.2 | 0.77 | 14.9 |
| C4 | Pd₁/AlₓSi_{y}O_{z} | 193~399 | 305.3 | 358.1 | 0.79 | 14.7 |
| C5 | Fe₁Ni₂/AlₓSi_{y}O_{z} | 201~383 | 189.4 | 339.4 | 0.83 | 15.4 |
| C6 | Mn₁Co₂/AlₓSi_{y}O_{z} | 207~407 | 304.6 | 383.2 | 0.84 | 15.9 |
| E6 | Pt/PdO/Al₂O₃ | 83~169 | 103.6 | 348.7 | 0.47 | 11.5 |
| C7 | Pt/PdO/Al₂O₃ | 82~179 | 111.5 | 357.3 | 0.49 | 12.2 |
| E7 | Ir₁Pd₁/TiO₂ | 29~62 | 37.9 | 243.5 | 0.19 | 20.1 |
| C8 | Ir₁/TiO₂ | 29~44 | 39.3 | 257.8 | 0.19 | 20.4 |
| C9 | Pd₁/TiO₂ | 22~38 | 31.7 | 267.3 | 0.19 | 20.8 |

### Degradation Effect of Catalyst Material on Airborne Molecular Contaminants

To verify the degradation effect of the catalyst materials in Examples 1 to 7 (E1 to E7) and Comparative Examples 1 to 9 (C1 to C9) on airborne molecular contaminants, as shown in Table 3, different control factors such as AMC gases (isopropanol (IPA) or acetone), whether an oxidizing agent (O₃) was added, and the AMC initial concentration (0.5 ppm or 100 ppm) were used. Each set of Examples was expanded into groups A, B, and C, for instance: Example 1 was expanded into Examples 1A to 1C (E1A to E1C). Comparative Examples were expanded into group A, for instance: Comparative Example 1 was expanded into Comparative Example 1A (C1A). Specifically, 0.5 g of the catalyst material from each set of Examples and Comparative Examples was evenly distributed on 0.1 g of quartz wool, which was then placed into a reaction tube (U-shaped glass tube, inner diameter 7 mm, length 150 mm) for oxidation reaction testing of isopropanol or acetone at different temperatures. The concentration of isopropanol or acetone at the inlet of the reaction tube was 0.5 ppm and 100 ppm, respectively, and the gas hourly space velocity (GHSV) of isopropanol or acetone was 6250 h⁻¹. Isopropanol or acetone was introduced into the reaction tube at different temperatures, and the concentration of isopropanol or acetone at the outlet of the reaction tube was measured to confirm the efficiency of the catalyst material in removing isopropanol or acetone at different temperatures. The test results are shown in Table 4.

TABLE 3
Test conditions for performance testing of catalyst
materials in Examples 1A to 7C (E1A to E7C) and Comparative
Examples 1A to 9A (C1A to C9A), including AMC gas,
oxidizing agent, and AMC initial concentration.

| | | | | AMC |
|---|---|---|---|---|
| | | | | Initial |
| Sample | | AMC | Oxidizing | Concentration |
| Code | Catalyst Material | Gas | Agent | (ppm) |
| E1A | Pt₁Pd₁/FeₓNi_{y}O_{z} | IPA | — | 0.5 |
| E1B | Pt₁Pd₁/FeₓNi_{y}O_{z} | Acetone | — | 0.5 |
| E1C | Pt₁Pd₁/FeₓNi_{y}O_{z} | Acetone | O₃ | 0.5 |
| C1A | Pt₁/FeₓNi_{y}O_{z} | IPA | — | 0.5 |
| C2A | Pd₁/FeₓNi_{y}O_{z} | IPA | — | 0.5 |
| E2A | Fe₁Pd₂/AlₓSi_{y}O_{z} | IPA | — | 0.5 |
| E2B | Fe₁Pd₂/AlₓSi_{y}O_{z} | Acetone | — | 0.5 |
| E2C | Fe₁Pd₂/AlₓSi_{y}O_{z} | Acetone | O₃ | 0.5 |
| E3A | Cu₁Pd₂/AlₓSi_{y}O_{z} | IPA | — | 0.5 |
| E3B | Cu1Pd₂/AlₓSi_{y}O_{z} | Acetone | — | 0.5 |
| E3C | Cu1Pd₂/AlₓSi_{y}O_{z} | Acetone | O₃ | 0.5 |
| E4A | Fe₁Ni₂/AlₓSi_{y}O_{z} | IPA | — | 0.5 |
| E4B | Fe₁Ni₂/AlₓSi_{y}O_{z} | Acetone | — | 0.5 |
| E4C | Fe₁Ni₂/AlₓSi_{y}O_{z} | Acetone | O₃ | 0.5 |
| E5A | Fe₁Co₂/AlₓSi_{y}O_{z} | IPA | — | 0.5 |
| E5B | Fe₁Co₂/AlₓSi_{y}O_{z} | Acetone | — | 0.5 |
| E5C | Fe₁Co₂/AlₓSi_{y}O_{z} | Acetone | O₃ | 0.5 |
| C3A | Cu₁/AlₓSi_{y}O_{z} | IPA | — | 0.5 |
| C4A | Pd₁/AlₓSi_{y}O_{z} | IPA | — | 0.5 |
| C5A | Fe₁Ni₂/AlₓSi_{y}O_{z} | IPA | — | 0.5 |
| C6A | Mn₁Co₂/AlₓSi_{y}O_{z} | IPA | — | 0.5 |
| E6A | Pt/PdO/Al₂O₃ | IPA | — | 100 |
| E6B | Pt/PdO/Al₂O₃ | Acetone | — | 100 |
| E6C | Pt/PdO/Al₂O₃ | Acetone | O₃ | 100 |
| C7A | Pt/PdO/Al₂O₃ | IPA | — | 100 |
| E7A | Ir₁Pd₁/TiO₂ | IPA | — | 0.5 |
| E7B | Ir₁Pd₁/TiO₂ | Acetone | — | 0.5 |
| E7C | Ir₁Pd₁/TiO₂ | Acetone | O₃ | 0.5 |
| C8A | Ir₁/TiO₂ | IPA | — | 0.5 |
| C9A | Pd₁/TiO₂ | IPA | — | 0.5 |

TABLE 4
Results of AMC removal efficiency at 25° C. and T₉₀ value
for performance testing of catalyst materials in Examples 1A
to 7C (E1A to E7C) and Comparative Examples 1A to 9A (C1A to C9A).

| | | Removal | |
|---|---|---|---|
| | | Efficiency | |
| Sample | | @25° C. | T90 Value |
| Code | Catalyst Material | (%) | (° C.) |
| E1A | Pt₁Pd₁/FeₓNi_{y}O_{z} | 90.5 | 25.0 |
| E1B | Pt₁Pd₁/FeₓNi_{y}O_{z} | 76.2 | 63.2 |
| E1C | Pt₁Pd₁/FeₓNi_{y}O_{z} | 99.0 | 25.0 |
| C1A | Pt₁/FeₓNi_{y}O_{z} | 10.3 | 92.3 |
| C2A | Pd₁/FeₓNi_{y}O_{z} | — | 254.3 |
| E2A | Fe₁Pd₂/AlₓSi_{y}O_{z} | 37.2 | 135.0 |
| E2B | Fe₁Pd₂/AlₓSi_{y}O_{z} | 39.6 | 121.0 |
| E2C | Fe₁Pd₂/AlₓSi_{y}O_{z} | 99.0 | 25.0 |
| E3A | Cu₁Pd₂/AlₓSi_{y}O_{z} | 59.6 | 92.5 |
| E3B | Cu₁Pd₂/AlₓSi_{y}O_{z} | 49.3 | 103.4 |
| E3C | Cu₁Pd₂/AlₓSi_{y}O_{z} | 99.0 | 25.0 |
| E4A | Fe₁Ni₂/AlₓSi_{y}O_{z} | 46.5 | 151.2 |
| E4B | Fe₁Ni₂/AlₓSi_{y}O_{z} | 40.7 | 164.5 |
| E4C | Fe₁Ni₂/AlₓSi_{y}O_{z} | 99.0 | 25.0 |
| E5A | Fe₁Co₂/AlₓSi_{y}O_{z} | 49.6 | 133.2 |
| E5B | Fe₁Co₂/AlₓSi_{y}O_{z} | 38.5 | 171.4 |
| E5C | Fe₁Co₂/AlₓSi_{y}O_{z} | 99.0 | 25.0 |
| C3A | Cu₁/AlₓSi_{y}O_{z} | 86.3 | 165.0 |
| C4A | Pd₁/AlₓSi_{y}O_{z} | — | 281.4 |
| C5A | Fe₁Ni₂/AlₓSi_{y}O_{z} | 4.4 | 213.5 |
| C6A | Mn₁Co₂/AlₓSi_{y}O_{z} | 16.4 | >200 |
| E6A | Pt/PdO/Al₂O₃ | 66.5 | 117.0 |
| E6B | Pt/PdO/Al₂O₃ | 32.5 | 167.0 |
| E6C | Pt/PdO/Al₂O₃ | 42.3 | 83.2 |
| C7A | Pt/PdO/Al₂O₃ | 31.2 | 156.8 |
| E7A | Ir₁Pd₁/TiO₂ | 54.3 | 82.1 |
| E7B | Ir₁Pd₁/TiO₂ | 42.3 | 99.5 |
| E7C | Ir₁Pd₁/TiO₂ | 98.5 | 27.3 |
| C8A | Ir₁/TiO₂ | 55.1 | 82.1 |
| C9A | Pd₁/TiO₂ | — | 299.4 |

The test results for the removal efficiency and T₉₀ values of the catalyst materials from Examples 1A to 7C (E1A to E7C) and Comparative Examples 1A to 9A (C1A to C9A) at 25° C. are shown in Table 4. In the experiments of the present invention, the Tso value was determined by gradually increasing the temperature until the removal efficiency reached 90%.

Comparing E1A and E1B with C1A and C2A, it can be seen that at 25° C., the removal efficiency of the catalyst materials from Example 1 (E1) for both IPA and acetone was significantly higher than that of Comparative Example 1 (C1). Furthermore, the removal duration of E1A and E1B was greater than 6000 hours (approximately 8.3 months), while C1A failed after only 12 hours, and C2A could not achieve measurable removal efficiency at room temperature due to its T₉₀ value being as high as 254.3° C. Moreover, the T₉₀ values indicate that E1A and E1B reached a removal efficiency of 90% at 25° C. and 63.2° C., respectively, which demonstrates a significant advantage in removal duration (service life) and removal temperature (reduced treatment cost) for E1A and E1B compared to C1A and C2A.

Comparing E3A and E3B with C3A and C4A, it can be seen that at 25° C., the removal efficiency of the catalyst materials from Example 3 (E3) for both IPA and acetone was lower than that of Comparative Examples 3 and 4 (C3 and C4). However, the removal duration of E3A and E3B exceeded 6000 hours (approximately 8.3 months), while C3A failed after only 9 hours, and C4A could not achieve measurable removal efficiency at room temperature due to its T₉₀ value being as high as 281.4° C. Furthermore, the T₉₀ values indicate that E3A and E3B achieved a removal efficiency of 90% at 92.5° C. and 103.4° C., respectively, showing a significant advantage for E3A and E3B in removal duration (service life) and removal temperature (reduced treatment cost) compared to C3A and C4A.

Comparing E4A and E4B with C5A, it can be seen that at 25° C., the removal efficiency of the catalyst materials from Example 4 (E4) for both IPA and acetone was significantly higher than that of Comparative Example 5 (C5). Furthermore, the removal duration of E4A and E4B exceeded 6000 hours (approximately 8.3 months), while C5A could not achieve measurable removal efficiency at room temperature due to its T₉₀ value being as high as 213.5° C. Moreover, the T₉₀ values indicate that E4A and E4B reached a removal efficiency of 90% at 151.2° C. and 164.5° C., respectively, showing a significant advantage in removal duration (service life) and removal temperature (reduced treatment cost) for E4A and E4B compared to C5A.

Comparing E5A and E5B with C6A, it can be seen that at 25° C., the removal efficiency of the catalyst materials from Example 5 (E5) for both IPA and acetone was significantly higher than that of Comparative Example 6 (C6). Furthermore, the removal duration of E5A and E5B exceeded 6000 hours (approximately 8.3 months), while C6A could not achieve measurable removal efficiency at room temperature due to its T₉₀ value exceeding 200° C. Moreover, the T₉₀ values indicate that E5A and E5B reached a removal efficiency of 90% at 133.2° C. and 171.4° C., respectively, showing a significant advantage in removal duration (service life) and removal temperature (reduced treatment cost) for E5A and E5B compared to C6A.

Comparing E6A and E6B with C7A, it can be seen that at 25° C., the removal efficiency of the catalyst materials from Example 6 (E6) for both IPA and acetone was significantly higher than that of Comparative Example 7 (C7). Furthermore, although E6A, E6B, and C7A all had a removal duration of more than 6000 hours (approximately 8.3 months), the T₉₀ value indicates that E6A achieved a 90% removal efficiency at 117° C., whereas C7A had a T₉₀ value of 156.8° C. This demonstrates that E6A has a notable advantage in removal duration (service life) and removal temperature (reduced treatment cost) compared to C7A.

Comparing E7A and E7B with C8A and C9A, it can be seen that at 25° C., the removal efficiency of the catalyst materials from Example 7 (E7) for both IPA and acetone was slightly lower than that of Comparative Example 8 (C8), but higher than that of Comparative Example 9 (C9). Furthermore, the removal duration of E7A and E7B exceeded 6000 hours (approximately 8.3 months), while C8A failed after only 19 hours, and C9A could not achieve measurable removal efficiency at room temperature due to its T₉₀ value being as high as 299.4° C. Moreover, the T₉₀ values indicate that E7A and E7B reached a removal efficiency of 90% at 82.1° C. and 99.5° C., respectively, whereas the T₉₀ value of C8A was also 82.1° C., but that of C9A was as high as 299.4° C. This shows that E7A and E7B have a notable advantage in removal duration (service life) and removal temperature (reduced treatment cost) compared to C8A and C9A.

Based on the above experimental results, the catalyst materials from Examples 1 to 7 (E1 to E7) demonstrated significantly better efficiency in removing IPA and acetone compared to the catalyst materials from Comparative Examples 1 to 9 (C1 to C9), regardless of the temperature conditions (room temperature or higher). Notably, the removal duration for E1 to E7 consistently exceeded 6000 hours. However, it must be emphasized that 6000 hours is not the failure time for the catalyst materials of E1 to E7; rather, it represents the maximum testing duration that could be conducted at the time of patent application. Therefore, the actual service life of E1 to E7 is expected to be longer. Additionally, the catalyst materials of E1 to E7 showed a distinct advantage in reducing the temperature required for AMC removal (T₉₀ value), contributing to lower operating costs.

It is also worth noting that although the formulations of some catalyst materials contain relatively low amounts of precious metals, the filter material of the present invention is designed to be recyclable due to the presence of these metals. This not only helps reduce resource waste but also further lowers material costs for long-term use, making it suitable for large-scale industrial applications and achieving sustainable development.

### Application of Catalyst Materials

To verify the degradation efficiency of airborne molecular contaminants using catalyst materials from Examples 1 to 7 (E1 to E7) applied to different support materials at varying loading amounts, support materials include but are not limited to sheet materials (e.g., woven or nonwoven fabrics), porous structured fillers, or mesh conductive substrates, with at least a portion of the catalyst material coated on the surface of the support material and capable of contacting the airborne molecular contaminants. In the application example, a preparation method and application of a sheet-like filter element (also referred to as an application of the catalyst material) are disclosed. Based on the total weight of the filter element as 100 wt %, the filter element comprises 1.7 wt % to 28.3 wt % of the catalyst material, 0.1 wt % to 5 wt % of the binder material, and 66.7 wt % to 98 wt % of the plastic material. The aforementioned catalyst material, binder material, and plastic material were processed using melt blowing and needle punching techniques to produce a nonwoven sheet form for the filter element. The filter element had rectangular shape with a thickness ranging from 0.4 mm to 1.5 mm. Subsequently, vacuum forming was used to process the filter element into a plurality of parallel raised linear corrugations, with the height of the corrugation peaks being 2.0 mm to 8.0 mm, the spacing between adjacent corrugation peaks being 2.5 mm to 12.0 mm, and the angle between the corrugation extension direction and the long side of the rectangular filter element being 45° to 75°.

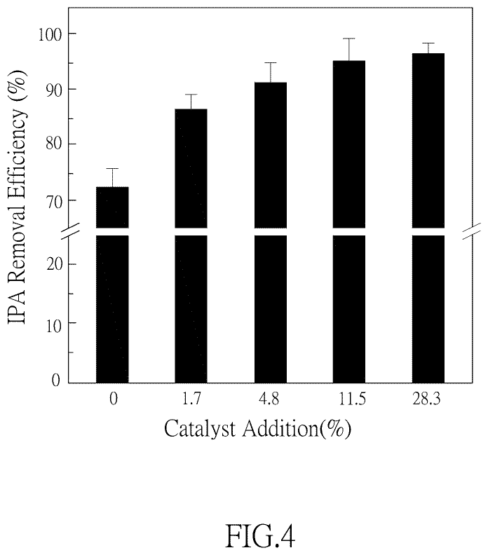

FIG. 4 shows Application Example 1 of the present invention, wherein the catalyst material (Fe₁Ni₂/AlₓSi_{y}O_{z}) from Example 4 (E4) was applied to the sheet material as the support material, and the removal efficiency of isopropanol (IPA) was tested.

### Application Example 1: Catalyst Material (Fe₁Ni₂/AlₓSi_{y}O_{z}) from Example 4 (E4) Applied to Sheet Material

In this Application Example 1, based on the total weight of the filter element as 100 wt %, the filter element comprises 0 wt %, 1.7 wt %, 4.8 wt %, 11.5 wt %, or 28.3 wt % of the catalyst material (Fe₁Ni₂/AlₓSi_{y}O_{z}) from Example 4 (E4). The binder material (2.5 wt %) was polyethylene oxide, and the plastic material was polyethylene terephthalate (PET) as the balance. The aforementioned catalyst material, binder material, and plastic material were processed using melt blowing and needle punching techniques to produce a nonwoven sheet form of the filter element. The filter element was rectangular in shape with a thickness of 0.8 mm. Subsequently, vacuum forming was used to process the filter element into a plurality of parallel raised linear corrugations, with the height of the corrugation peaks being 6.0 mm, the spacing between adjacent corrugation peaks being 7 mm, and the angle between the corrugation extension direction and the long side of the rectangular filter element being 65°. The filter element was then cut into multiple squares of 0.15×0.5 m², followed by filling them into the reaction tube (U-shaped glass tube, inner diameter of 7 mm, tube length of 150 mm) to achieve a packing volume of 0.15 m³. The reaction tube temperature was maintained at 25° C., and 100 ppm of volatile isopropanol was introduced at the inlet, with a GHSV of 15000 h⁻¹. The isopropanol concentration at the outlet of the reaction tube was measured to determine the removal efficiency of isopropanol by the filter element. As shown in FIG. 4, tests were conducted in the absence of the catalyst material and with four different loading ratios of the catalyst materials. Taking a removal efficiency of 90% for isopropanol as the benchmark, when the catalyst material of the present invention was not added (0 wt %), only 72.5±3.3% of isopropanol could be removed by the adsorption capacity of the plastic material itself. However, with an increase in catalyst material loading, even at a low loading of 4.8 wt %, 91.4±3.6% of isopropanol could be effectively removed. Furthermore, with an increase in loading to 28.3 wt %, the removal efficiency further increased to 96.5±1.9%. This indicates that the catalyst material of the present invention can achieve an excellent removal efficiency for gaseous pollutants by adding only a small amount to a nonwoven sheet form of the sheet material, providing significant economic and industrial application value.

In summary, the catalyst materials of the present invention demonstrated excellent removal efficiency for gaseous pollutants in Application Example 1. In Application Example 1, the catalyst material achieved a removal efficiency of 95.3% with a loading as low as 4.8 wt %, and the removal efficiency further improved with increased loading. The results of the above application example indicate that the catalyst materials of the present invention exhibit stable and efficient pollutant removal performance when applied to support materials, demonstrating significant industrial application potential and cost-effectiveness.

1. A catalyst material, comprising:
a carrier; and
a first transition metal and a second transition metal, the first transition metal and the second transition metal being loaded in a single-atom form on the carrier;
wherein the carrier is selected from the group consisting of iron-nickel oxide (FexNiyOz), silicon-aluminum oxide (AlxSiyOz), aluminium oxide (Al2O3), and titanium dioxide (TiO2); the first transition metal is Fe, Cu, Ir, or Pt, and the second transition metal is Pd, Ni, or Co; based on a total catalyst material weight of 100 wt %, the combined weight percentage of the first transition metal and the second transition metal is in a range from 0.2 wt % to 2.5 wt %; and, based on a total molar fraction of 100% for the first transition metal and the second transition metal, the molar fraction of the second transition metal is 1 to 2 times the molar fraction of the first transition metal.

2. The catalyst material according to claim 1, wherein the first transition metal and the second transition metal are both single-atom metals.

3. The catalyst material according to claim 1, wherein the sizes of the first transition metal and the second transition metal are in a range from 0.2 nm to 3.0 nm.

4. The catalyst material according to claim 1, wherein the size of the catalyst material is ranging from 29 nm to 412 nm, with a D50 value in a range from 37.9 nm to 337.3 nm.

5. The catalyst material according to claim 1, wherein the BET specific surface area of the catalyst material is in a range from 119.4 m2/g to 402.1 m2/g.

6. The catalyst material according to claim 1, wherein the total pore volume of the catalyst material is in a range from 0.19 cm3/g to 0.81 cm3/g.

7. The catalyst material according to claim 1, wherein the pore size of the catalyst material is in a range from 9.2 nm to 47.2 nm.

8. An application of the catalyst material according to claim 1, wherein the catalyst material is added to a support material, such that the catalyst material and the support material together form a filter element for filtering airborne molecular contaminants (AMC), which is used for contacting and decomposing the airborne molecular contaminants.

9. The application according to claim 8, wherein, based on a total weight of 100 wt % of the filter element, the filter element is formed by uniformly mixing 70 wt % to 99.9 wt % of a polymer composition with 0.1 wt % to 30 wt % of the catalyst material, and then producing a nonwoven sheet-type filter element using melt blowing and spinning techniques, wherein the polymer composition comprises at least a plastic material and a binder material.

10. The application according to claim 9, wherein, based on a total weight of 100 wt % of the filter element, the filter element comprises 1.7 wt % to 28.3 wt % of the catalyst material, 0.1 wt % to 5 wt % of the binder material, and 66.7 wt % to 98 wt % of the plastic material.

11. The application according to claim 10, wherein, based on a total weight of 100 wt % of the filter element, the filter element comprises 4.8 wt % to 28.3 wt % of the catalyst material, 0.1 wt % to 5 wt % of the binder material, and 66.7 wt % to 95.1 wt % of the plastic material.

12. The application according to claim 10, wherein the plastic material is polyethylene, polypropylene, polyethylene terephthalate, polyethylene terephthalate glycol (PETG), cyclohexanedimethanol, or nylon.

13. The application according to claim 12, wherein the binder material is polyvinyl alcohol, polyethylene oxide, polyvinyl acetate, ethylene-vinyl acetate copolymer, poly(acrylic acid) (PAA), or polyurethane.

14. The application according to claim 8, wherein the AMC comprising acetone, isopropanol (IPA), ethanol, ethyl acetate, toluene, xylene, trichloroethylene, propylene glycol monomethyl ether (PGME), propylene glycol monomethyl ether acetate (PGMEA), dimethyl sulfoxide (DMSO), or N-methyl-2-pyrrolidone (NMP).
